(19) United States
(12) Patent Application Publication
(10) Pub. No.: US 2025/0324150 A1
(43) Pub. Date: Oct. 16, 2025

(54) IMAGE CAPTURING APPARATUS HAVING MOVABLE IMAGE SENSOR

(71) Applicant: CANON KABUSHIKI KAISHA, Tokyo (JP)

(72) Inventor: TATSUYA OTOSHI, Tokyo (JP)

(21) Appl. No.: 19/094,135

(22) Filed: Mar. 28, 2025

(30) Foreign Application Priority Data
Apr. 11, 2024 (JP) 2024-063885

(51) Int. Cl. H04N 23/54

(52) U.S. Cl. CPC H04N 23/54

(57) ABSTRACT

An image capturing apparatus capable of suppressing enlargement of an image capturing apparatus even when a width of a wiring portion of an FPC is increased. The image capturing apparatus includes an image sensor, a first unit, a second unit on which the image sensor is arranged so as to move that the image sensor relative to the first unit in a plane orthogonal to an optical axis of an image capturing optical system, and a first wiring member and a second wiring member that electrically connect the first unit and the second unit. The first wiring member and the second wiring member overlap by a predetermined amount when viewed from an optical axis direction of the image capturing optical system and are separated in the optical axis direction in a portion overlapping by the predetermined amount.

### BACKGROUND OF THE INVENTION

### Field of the Invention

The present invention relates to image capturing apparatuses, and in particular to an image capturing apparatus having a movable image sensor.

### Description of the Related Art

Conventionally, a drive device is known that moves a movable portion relative to a fixed portion in a plane.

An example of application of such a drive device is an image stabilization mechanism mounted on an image capturing apparatus. In the image stabilization mechanism, a circuit board on which an image sensor and an electrical connection component such as a connector are implemented is mounted on the movable portion. On the other hand, a controller to drivingly control the movable portion is mounted on the fixed portion like a casing that holds the movable portion, and an electrical connection component such as a connector is also implemented on the fixed portion.

The electrical connection components mounted on the movable portion and the fixed portion are electrically connected via a flexible printed circuit board (FPC). Flexibility of the FPC allows the controller mounted on the fixed portion to drivingly control the movable portion in a state where the fixed portion is electrically connected to the movable portion.

In recent years, power consumption and the number of connection signals of the image sensor have been increased in order to increase the number of pixels of a moving image and to improve functions such as high-speed continuous shooting of the image capturing apparatus, which increases a width of the wiring portion of the FPC. Such an increase in the width of the wiring portion of the FPC causes a load on the driving of the movable portion. In view of this issue, Japanese Patent Laid-Open Publication No. 2020-64281 (Counterpart of US 20200120251 A1) discloses a technique of reducing the load on the driving of the movable portion by arranging a plurality of FPCs so as not to overlap each other when the image capturing apparatus is viewed from a rear side.

However, when the FPCs are arranged so as not to overlap each other as in the technique of the above publication as a measure against the increase in the width of the wiring portion of the FPC with the improvement of the function of the image capturing apparatus, the image stabilization mechanism may be enlarged. This may lead to enlarge the size of the image capturing apparatus.

### SUMMARY OF THE INVENTION

The present invention provides a technique to suppress enlargement of an image capturing apparatus even when a width of a wiring portion of an FPC is increased.

Accordingly, an aspect of the present invention provides an image capturing apparatus including an image sensor, a first unit, a second unit on which the image sensor is arranged so as to move that the image sensor relative to the first unit in a plane orthogonal to an optical axis of an image capturing optical system, and a first wiring member and a second wiring member that electrically connect the first unit and the second unit. The first wiring member and the second wiring member overlap by a predetermined amount when viewed from an optical axis direction of the image capturing optical system and are separated in the optical axis direction in a portion overlapping by the predetermined amount.

According to the present invention, it is possible to provide an image capturing apparatus that suppresses enlargement even when the width of the wiring portion of the FPC is increased.

Further features of the present invention will become apparent from the following description of exemplary embodiments with reference to the attached drawings.

### BRIEF DESCRIPTION OF THE DRAWINGS

FIG. 1 is a view illustrating a schematic configuration of an image capturing apparatus according to a first embodiment of the present invention.

FIG. 2 is an exploded perspective view illustrating an image stabilization unit, which has a movable portion and a fixed portion, included in the image capturing apparatus in FIG. 1.

FIG. 3 is another exploded perspective view illustrating the image stabilization unit included in the image capturing apparatus.

FIG. 4 is an exploded perspective view illustrating the movable portion.

FIG. 5 is another exploded perspective view illustrating the movable portion.

FIG. 6 is an exploded perspective view illustrating a biasing magnetic circuit and a sensing magnetic circuit formed by combining the movable portion and the fixed portion.

FIG. 7A and FIG. 7B are a projected plan view in an optical axis direction and a sectional view illustrating the sensing magnetic circuit.

FIG. 8 is an exploded perspective view illustrating the image capturing apparatus.

FIG. 9A and FIG. 9B are a projected plan view in the optical axis direction and a sectional view illustrating a first image capturing FPC in FIG. 8 at a time of assembly.

FIG. 10A and FIG. 10B are a projected plan view in the optical axis direction and a sectional view illustrating a second image capturing FPC in FIG. 8 at a time of assembly.

FIG. 11A to FIG. 11C are a projected plan view in the optical axis direction and sectional views illustrating a third image capturing FPC in FIG. 8 at a time of assembly.

FIG. 12A and FIG. 12B are a projected plan view in the optical axis direction and a sectional view illustrating constituent parts of a heat dissipation path of the image sensor in FIG. 1.

FIG. 13A and FIG. 13B are a projected plan view in the optical axis direction and a sectional view illustrating the image stabilization unit according to the first embodiment.

FIG. 14A to FIG. 14D are a projected plan view in the optical axis direction and sectional views showing an image capturing FPC according to a second embodiment.

### DESCRIPTION OF THE EMBODIMENTS

Hereafter, embodiments according to the present invention will be described in detail by referring to the drawings. In the embodiments, an image capturing apparatus according to the present invention in which a drive device is applied to an image stabilizer will be described as an example. However, the application example of the drive device is not limited to the image stabilizer.

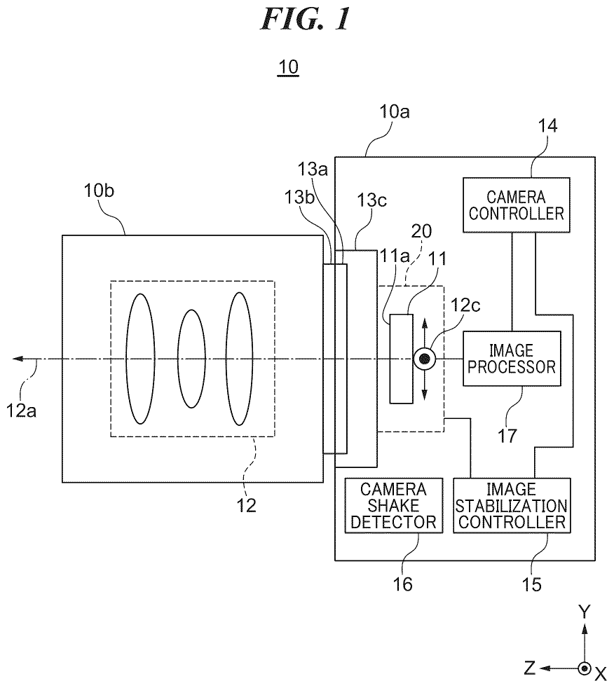

FIG. 1 is a view illustrating a schematic configuration of an image capturing apparatus 10 according to a first embodiment of the present invention.

The image capturing apparatus 10 is what is called a mirrorless digital camera and includes an image capturing apparatus body 10a (hereinafter referred to as a “body 10a”) and a lens barrel 10b that is detachably attachable to the body 10a.

The body 10a includes an image sensor 11 having a substantially rectangular image capturing surface 11a, a body-side mount member 13a, a base member 13c, a camera controller 14, an image stabilization controller 15, a camera shake detector 16, an image processor 17, and an image stabilization unit 20. The lens barrel 10b includes an image capturing optical system 12 and a lens-side mount member 13b.

A plane orthogonal to an optical axis 12a of the image capturing optical system 12 is defined as an optical-axis orthogonal plane 12c. The optical axis 12a passes through the center of the image capturing surface 11a and is orthogonal to the image capturing surface 11a. In order to clarify arrangements and positional relationships of respective parts constituting the image capturing apparatus 10 in the image capturing apparatus 10, X, Y, and Z directions orthogonal to each other are defined as shown in FIG. 1. The Z direction is parallel to the optical axis 12a, the X direction is a width direction of the image capturing apparatus 10, and the Y direction is a height direction of the image capturing apparatus 10. Therefore, the optical-axis orthogonal plane 12c corresponds to an XY plane. When both the X direction and the Z direction are in a horizontal plane, the Y direction becomes a vertical direction.

The image sensor 11 is configured by a photoelectric conversion element, such as a CMOS image sensor or a CCD image sensor, and is disposed such that the image capturing surface 11a is directed to an object side (the side of the lens barrel 10b) and the image capturing surface 11a is orthogonal to the optical axis 12a. The image sensor 11 generates an image signal by photoelectrically converting an optical image of an object formed on the image capturing surface 11a by the image capturing optical system 12. The image signal generated by the image sensor 11 is converted into image data by applying various processes in the image processor 17, and is stored in a memory (storage device) that is not shown.

The camera controller 14 is a calculation means in a main IC (not shown) and receives an input operation from a user through an operation means (not shown) to control the overall operations of the image capturing apparatus 10.

The image capturing optical system 12 is configured by lens groups disposed inside the lens barrel 10b and images a light flux incident from the object side on the image capturing surface 11a of the image sensor 11. Although three lenses included in the lens groups are illustrated in FIG. 1, the number of lenses included in the lens groups is not limited to three, and may be one or more. In the image capturing apparatus 10, the image sensor 11 is attached to the base member 13c provided on the body 10a and the lens barrel 10b is also connected to the base member 13c, so that the image sensor 11 is arranged with high positional accuracy with respect to the optical axis 12a. At this time, the image sensor 11 is attached to the base member 13c via the image stabilization unit 20. The lens barrel 10b is connected to the base member 13c via the lens-side mount member 13b and the body-side mount member 13a.

The image stabilization unit 20 corrects image blur caused by shake of the image capturing apparatus 10 by moving or rotating the image sensor 11 in the optical-axis orthogonal plane 12c, and thus enables to obtain a clear object image. Specifically, when the posture of the image capturing apparatus 10 changes with respect to the object during image capturing, an imaging position of an object light flux on the image capturing surface 11a of the image sensor 11 changes, and thus blur occurs in the image obtained through the image sensor 11. At this time, when the posture change of the image capturing apparatus 10 is sufficiently small, the change of the imaging position is uniform in the image capturing surface 11a and can be regarded as at least one of the movement and the rotation (image plane blur) in the optical-axis orthogonal plane 12c. Therefore, when at least one of the movement and the rotation of the image sensor 11 in the optical-axis orthogonal plane 12c is executed so as to cancel the image plane blur, a clear object image in which the image blur is corrected can be obtained. The image sensor 11 may be moved also in a direction perpendicular to the image capturing surface when the image sensor 11 is moved in a direction parallel to the image capturing surface.

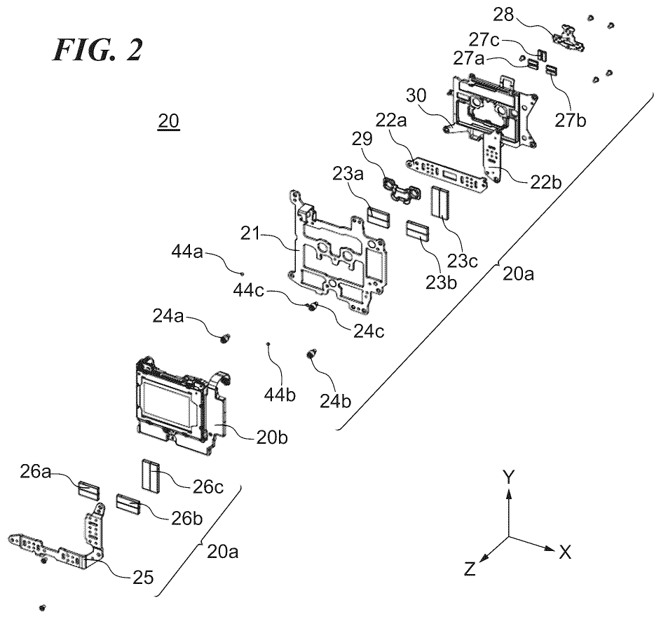

The image stabilization unit 20 is generally constituted by a fixed portion 20a, a movable portion 20b, and a plurality of balls 44a, 44b, 44c, as shown in FIG. 2. The fixed portion 20a is fixed to the base member 13c, and the movable portion 20b holds the image sensor 11. The movable portion 20b is supported by the fixed portion 20a with three degrees of freedom, and is disposed so as to be movable and rotatable relative to the fixed portion 20a within the optical-axis orthogonal plane 12c. That is, the image stabilization unit 20 is configured as a drive device (what is called an XYθ stage) capable of drive control in three axes, and can move and rotate the image sensor 11 within the optical-axis orthogonal plane 12c.

The camera shake detector 16 is configured by a gyrosensor and an acceleration sensor, and functions as a camera shake detection means that detects angular velocity and acceleration of the image capturing apparatus 10 in each direction as camera shake information of image capturing apparatus 10.

The image stabilization controller 15 calculates an angular change amount and a moving amount in each direction of the image capturing apparatus 10 on the basis of the camera shake information such as the angular velocity and acceleration detected by the camera shake detector 16. Further, the image stabilization controller 15 calculates a movement target value of the image sensor 11 on the basis of the shake information detected by the camera shake detector 16 and controls the driving of the image stabilization unit 20, thereby controlling the movement of the image sensor 11. A known method may be used as a method for calculating the angular change amount, the moving amount, and the movement target value based on the shake information, and thus a detailed description thereof will be omitted.

Next, details of the configuration of the image stabilization unit 20 will be described.

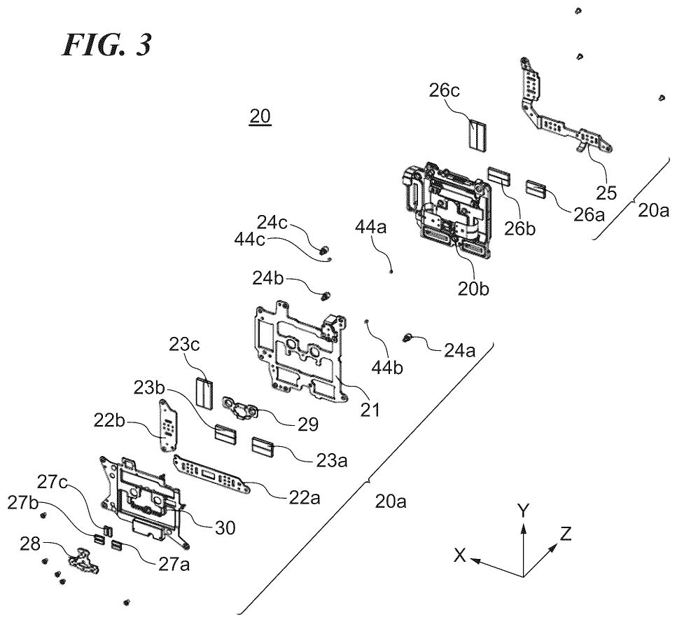

FIG. 2 and FIG. 3 are exploded perspective views illustrating the image stabilization unit 20. FIG. 2 and FIG. 3 are different in a direction viewing the image stabilization unit 20. The image stabilization unit 20 includes the fixed portion 20a (a first unit) and the movable portion 20b (a second unit). In FIG. 2 and FIG. 3, the movable portion 20b is illustrated in an assembled manner, and the fixed portion 20a is illustrated in a disassembled manner. Each of the fixed portion 20a and the movable portion 20b is configured by combining one or more members. The parts shown in FIG. 2 and FIG. 3 constitute the fixed portion 20a except for the movable portion 20b and the balls 44a, 44b, and 44c.

The fixed portion 20a includes a fixing member 21, a first rear yoke 22a, a second rear yoke 22b, a first rear magnet pair 23a, a second rear magnet pair 23b, and a third rear magnet pair 23c. The first rear magnet pair 23a and the second rear magnet pair 23b are fixed to the first rear yoke 22a, and the third rear magnet pair 23c is fixed to the second rear yoke 22b, with adhesives.

The fixed portion 20a also includes a first column member 24a, a second column member 24b, a third column member 24c, a front yoke 25, a first front magnet pair 26a, a second front magnet pair 26b, and a third front magnet pair 26c. The front yoke 25 is fixed to the fixing member 21 with screws via the first column member 24a, the second column member 24b, and the third column member 24c. The first front magnet pair 26a, the second front magnet pair 26b, and the third front magnet pair 26c are fixed to the front yoke 25 with adhesives.

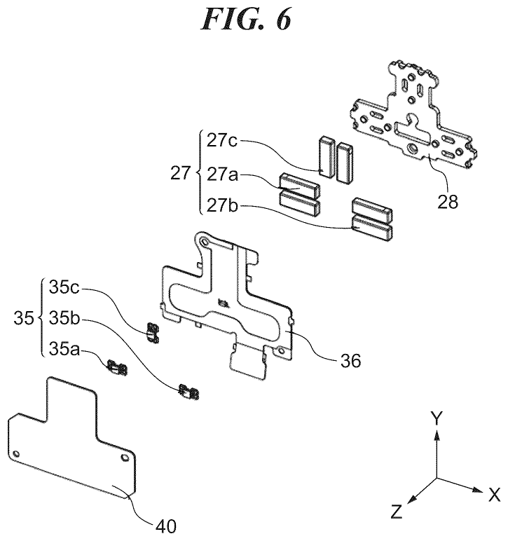

The fixed portion 20a further includes a first sensing magnet pair 27a, a second sensing magnet pair 27b, a third sensing magnet pair 27c, a sensing yoke 28, a regulation member 29, and a cover 30. The first sensing magnet pair 27a, the second sensing magnet pair 27b, and the third sensing magnet pair 27c constitute a sensing magnet group 27 (see FIG. 6). In the present embodiment, each of the first sensing magnet pair 27a, the second sensing magnet pair 27b, and the third sensing magnet pair 27c uses two magnets magnetized in the optical axis direction (Z direction) that are arranged with a gap therebetween so as to generate magnetic fields in opposite directions. However, this is not limited, and one magnet magnetized in two poles may be used. The first sensing magnet pair 27a, the second sensing magnet pair 27b, and the third sensing magnet pair 27c are fixed to the sensing yoke 28 with adhesives. The first rear yoke 22a, the second rear yoke 22b, the front yoke 25, and the sensing yoke 28 are made of magnetic material to play roles of yokes.

The fixed portion 20a is a unit serving as a reference of a position when the movable portion 20b moves, and thus is expressed as the fixed portion 20a, but the fixed portion 20a may be movably held so that the position of the fixed portion 20a can be adjusted with respect to the body 10a.

Further, as will be described later, the movable portion 20b is supported by the fixed portion 20a via the plurality of balls, but for example, the movable portion 20b may be supported by the base member 13c by connecting via springs or wires therebetween.

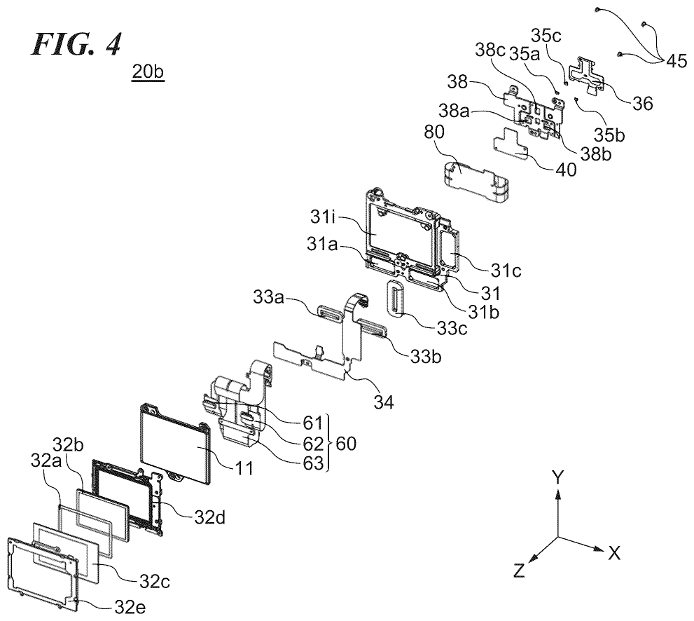

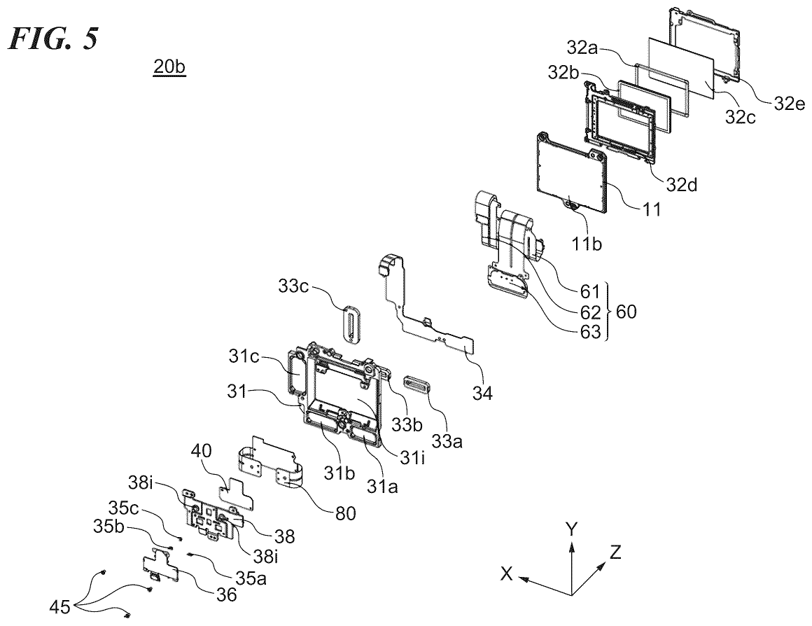

FIG. 4 and FIG. 5 are exploded perspective views illustrating the movable portion 20b. FIG. 4 and FIG. 5 are different in a direction viewing the movable portion 20b.

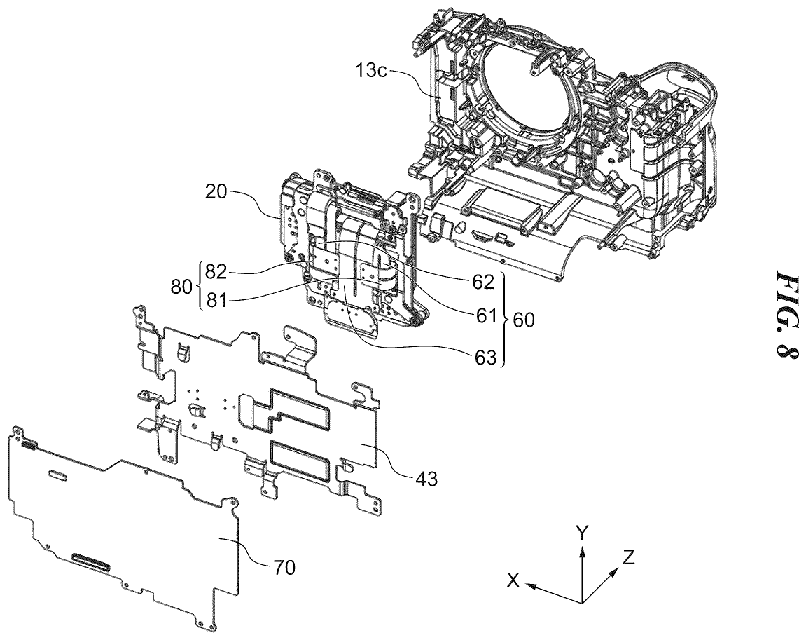

The movable portion 20b includes an image sensor holder 31 and the image sensor 11 that is fixed to the image sensor holder 31 with screws or an adhesive (not shown). One ends of a first image capturing FPC 61, a second image capturing FPC 62, and a third image capturing FPC 63, which constitute an image capturing FPC group 60, are connected to the image sensor 11. The other ends of the first image capturing FPC 61, the second image capturing FPC 62, and the third image capturing FPC 63 are connected to a control board 70 (FIG. 8). And thus, via the image capturing FPC group 60, electric power is supplied to the image sensor 11 and an image capturing signal is transferred from the image sensor 11. Details thereof will be described later. The image sensor 11 is fixed to an image sensor board 11b (FIG. 5).

The movable portion 20b also includes a mask 32a, an infrared absorbing filter 32b, and an optical low pass filter 32c. The mask 32a, the infrared absorbing filter 32b, and the optical low pass filter 32c are held by a filter holder 32d and a holder metal plate 32e, and are fixed to the image sensor 11 with an adhesive. At least one of the mask 32a, the infrared absorbing filter 32b, and the optical low pass filter 32c may not be provided.

The movable portion 20b further includes a first coil 33a, a second coil 33b, a third coil 33c and a drive FPC 34. The drive FPC 34 is electrically connected to the first coil 33a, the second coil 33b, and the third coil 33c. The drive FPC 34 is disposed so as to overlap the first coil 33a, the second coil 33b, and the third coil 33c on the optical-axis orthogonal plane (on the XY plane when viewed in the Z direction), and is fixed to the image sensor holder 31 with an adhesive.

The image sensor holder 31 has a first opening 31a, a second opening 31b, and a third opening 31c. The first coil 33a is disposed inside the first opening 31a, the second coil 33b is disposed inside the second opening 31b, and the third coil 33c is disposed inside the third opening 31c.

The movable portion 20b also includes a coupling member 38 that bridges an opening 31i of the image sensor holder 31 and is fixed to the image sensor holder 31 with screws 45 on both sides across the optical axis. That is, the coupling member 38 is disposed opposite to the image sensor 11. The coupling member 38 is provided with two contact portions 38i (FIG. 5). The movable portion 20b is movable in the optical-axis orthogonal plane 12c as long as the contact portions 38i do not contact the regulation member 29 of the fixed portion 20a. That is, the contact portions 38i and the regulation member 29 regulate the movable range of the movable portion 20b within a predetermined range.

A thrust yoke 40 and a heat transfer member group 80 are fixed to one side of the coupling member 38 in the optical axis direction, and the sensing FPC 36 is fixed to the other side with adhesives. The thrust yoke 40 is made of magnetic material to play a role of a yoke.

The sensing FPC 36 is implemented with a first sensor 35a, a second sensor 35b, and a third sensor 35c. Hall elements are used for these detectors, for example. The first sensor 35a, the second sensor 35b, and the third sensor 35c constitute a sensor group 35 (FIG. 6).

The coupling member 38 has a first opening 38a, a second opening 38b, and a third opening 38c. The first sensor 35a is disposed inside the first opening 38a, the second sensor 35b is disposed inside the second opening 38b, and the third sensor 35c is disposed inside the third opening 38c.

As shown in FIG. 2 and FIG. 3, the first ball 44a, the second ball 44b, and the third ball 44c are provided between the fixed portion 20a and the movable portion 20b. When the movable portion 20b is moved, the first ball 44a, the second ball 44b, and the third ball 44c roll, and thus the movable portion 20b can smoothly move on the optical-axis orthogonal plane 12c with respect to the fixed portion 20a.

The fixed portion 20a and the movable portion 20b are combined to form VCMs (Voice Coil Motors), sensing magnetic circuits, and biasing magnetic circuits. These circuits will be described below.

First, the VCMs (Voice Coil Motors) will be described.

In the fixed portion 20a, the first rear magnet pair 23a and the first front magnet pair 26a arranged side by side in the optical axis direction form a first driving magnetic circuit. Similarly, the second rear magnet pair 23b and the second front magnet pair 26b form a second driving magnetic circuit, and the third rear magnet pair 23c and the third front magnet pair 26c form a third driving magnetic circuit. The first driving magnetic circuit and the first coil 33a of the movable portion 20b form a VCM as a first actuator. The second driving magnetic circuit and the second coil 33b of the movable portion 20b form a VCM as a second actuator. The third driving magnetic circuit and the third coil 33c of the movable portion 20b form a VCM as a third actuator. A Lorentz force is generated in a direction orthogonal to both a magnetic field generated in the optical axis direction by the first driving magnetic circuit and electric current flowing through the first coil 33a. A resultant force direction of the Lorentz force changes in accordance with the direction of the electric current flowing through the first coil 33a. Similar Lorentz forces are generated in the second driving magnetic circuit and the second coil 33b, and in the third driving magnetic circuit and the third coil 33c. The first actuator and the second actuator generate forces (driving forces) substantially parallel to the Y direction, and a moving force in the Y direction is generated by the sum of the forces, and a rotational force around the optical axis is generated by the difference between the forces. On the other hand, the third actuator generates a moving force in the X direction.

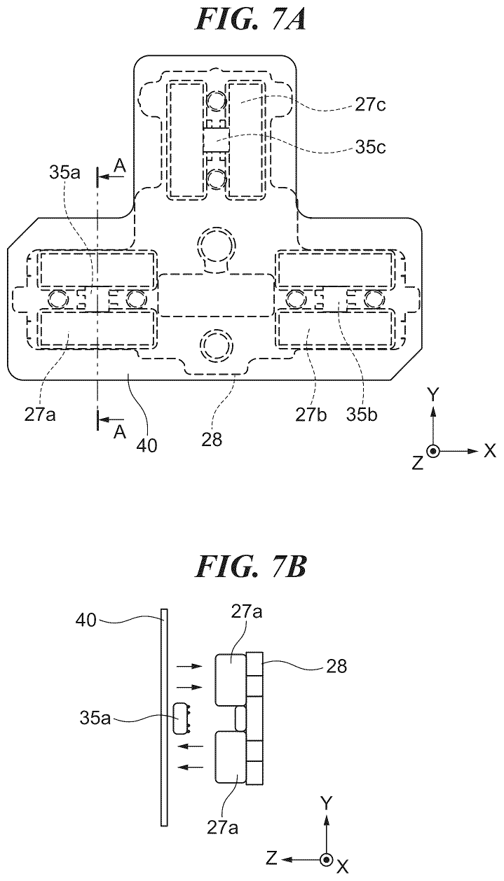

The biasing magnetic circuits and the sensing magnetic circuits will now be described using FIG. 6, FIG. 7A, and FIG. 7B.

FIG. 6 is an exploded perspective view illustrating the biasing magnetic circuit and the sensing magnetic circuit. FIG. 7A is a projected plan view illustrating the sensing magnetic circuit when viewed from the object side in the optical axis direction. The FIG. 7B is a sectional view along a line A-A shown in the FIG. 7A.

First, the biasing magnetic circuit will be described.

As shown in FIG. 6, the fixed portion 20a has the sensing magnet group 27, and the movable portion 20b is provided with the thrust yoke 40 at a position opposite to the sensing magnet group 27. The first sensing magnet pair 27a will be described. As illustrated in FIG. 7B, magnetic fluxes of the first sensing magnet pair 27a flowing through the thrust yoke 40 generate an attractive force between the first sensing magnet pair 27a and the thrust yoke 40. Similarly, attractive forces are generated between the second sensing magnet pair 27b and the thrust yoke 40 and between the third sensing magnet pair 27c and the thrust yoke 40. In this way, the attraction forces act between the sensing magnet group 27 of the fixed portion 20a and the thrust yoke 40 of the movable portion 20b, and thus the movable portion 20b is biased in the optical axis direction (Z direction) with respect to the fixed portion 20a.

Next, the sensing magnetic circuit will be described.

The thrust yoke 40, the first sensing magnet pair 27a, and the sensing yoke 28, which are arranged in the optical axis direction, form a first sensing magnetic circuit. Similarly, the thrust yoke 40, the second sensing magnet pair 27b, and the sensing yoke 28 form a second sensing magnetic circuit, and the thrust yoke 40, the third sensing magnet pair 27c, and the sensing yoke 28 form a third sensing magnetic circuit.

The first sensor 35a is arranged opposite the first sensing magnet pair 27a, the second sensor 35b is arranged opposite the second sensing magnet pair 27b, and the third sensor 35c is arranged opposite the third sensing magnet pair 27c. The thrust yoke 40 is disposed on the opposite side of the sensing magnet group 27 across the sensor group 35 in the optical axis direction. Further, the thrust yoke 40 is disposed so as to cover the sensor group 35 when viewed from the optical axis direction.

The first sensing magnetic circuit and the first sensor 35a are described using FIG. 7B. The first sensor 35a is disposed between the first sensing magnet pair 27a and the thrust yoke 40. Therefore, the position detection is performed by the first sensor 27a within the magnetic fluxes of the first sensing magnet pair 35a flowing through the thrust yoke 40. Similarly, the position detection is performed by the second sensor 27b within the magnetic fluxes of the second sensing magnet pair 35b flowing through the thrust yoke 40. Further, the position detection is performed by the third sensor 27c within the magnetic fluxes of the third sensing magnet pair 35c flowing through the thrust yoke 40. In this way, the position detection is performed by the sensor group 35 in the magnetic fields formed by the sensing magnet group 27 of the fixed portion 20a and the thrust yoke 40 of the movable portion 20b, and thus the position detection can be performed with high accuracy. In the present embodiment, the sensing magnet group 27 is disposed in the fixed portion 20a, and the sensor group 35 is disposed in the movable portion 20b. This is because the sensor group 35 is lighter than the sensing magnet group 27, and thus the driving load of the movable portion 20b in the configuration in which the sensor group 35 is disposed in the movable portion 20b is smaller than that in the configuration in which the sensing magnet group 27 is disposed in the movable portion 20b.

Although the thrust yoke 40 can increase the position detection accuracy with the sensor group 35 because the magnetic fields are more stable than the configuration not having the thrust yoke 40, the thrust yoke 40 is not essential in the position detection with the sensor group 35.

Further, although the configuration in which the thrust yoke 40 is used for both the biasing magnetic circuit and the sensing magnetic circuit has been described, separate yokes may be prepared for the biasing magnetic circuit and the sensing magnetic circuit.

FIG. 8 is an exploded perspective view illustrating the image capturing apparatus 10. The image capturing FPC group 60 connects the image sensor 11 in the image stabilization unit 20 and the control board 70. The image capturing FPC group 60 (two or more wiring members) is constituted by the first image capturing FPC 61, the second image capturing FPC 62, and the third image capturing FPC 63 as described above. The heat transfer member group 80 includes a first heat transfer member 81 and a second heat transfer member 82 that are provided at opposite positions when viewed from the Z direction. One end of the heat transfer member group 80 is connected to the movable portion 20b, and the other end is connected to a support member 43 of the fixed portion 20a. The support member 43 is connected to the base member 13c.

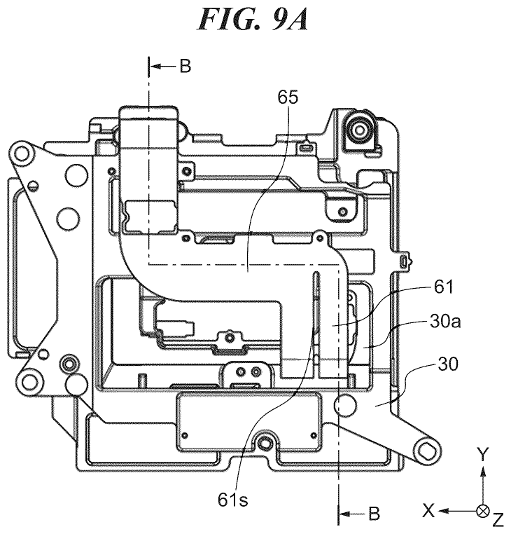

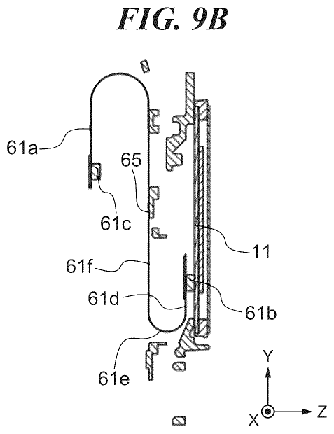

Next, the image capturing FPC group 60 will be described using FIG. 9A to FIG. 11C.

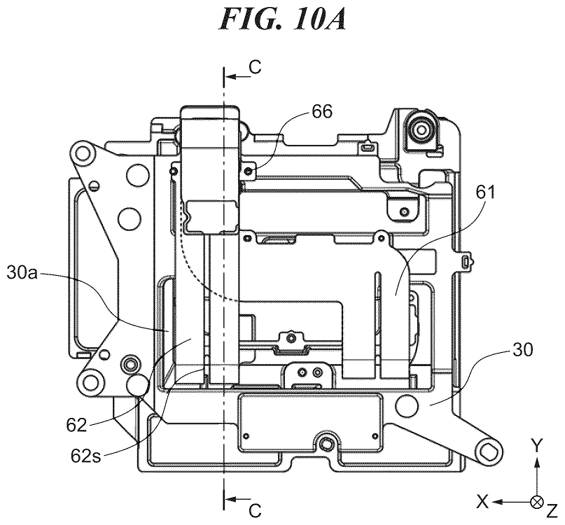

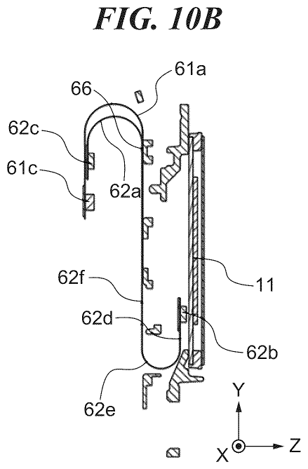

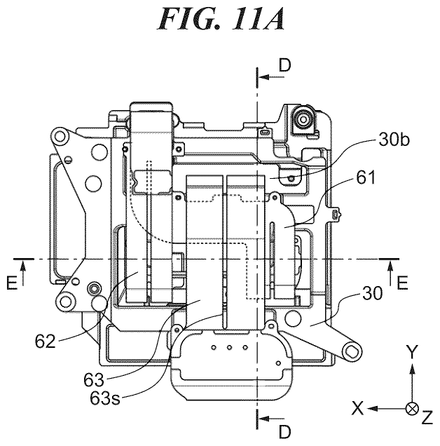

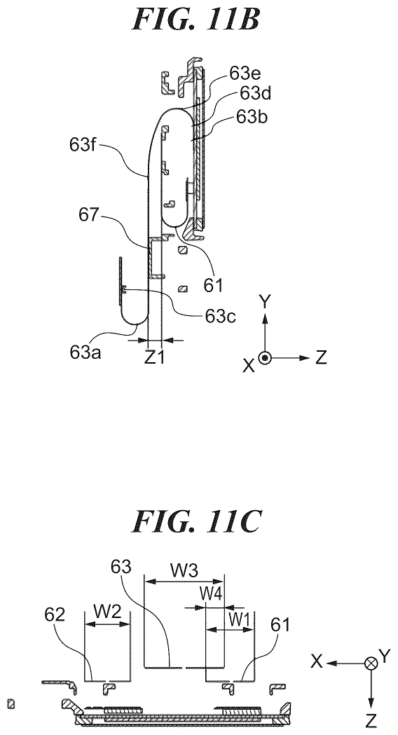

FIG. 9A and FIG. 9B, FIG. 10A and FIG. 10B, and FIG. 11A to FIG. 11C are arranged in the order of assembly of the image capturing FPCs. FIG. 9A and FIG. 9B are a projected plan view in the optical axis direction and a sectional view at a time of assembling the first image capturing FPC 61. FIG. 9A is the projected plan view and FIG. 9B is the sectional view along a line B-B shown in FIG. 9A. FIG. 10A and FIG. 10B are a projected plan view in the optical axis direction and a sectional view at a time of assembling the second image capturing FPC 62. FIG. 10A is the projected plan view and FIG. 10B is the sectional view along a line C-C shown in FIG. 10A. FIG. 11A to FIG. 11C are a projected plan view in the optical axis direction and sectional views at a time of assembling the third image capturing FPC 63. FIG. 11A is the projected plan view, FIG. 11B is the sectional view along a line D-D shown in FIG. 11A, and FIG. 11C is the sectional view along a line E-E shown in FIG. 11A.

In FIG. 9A to FIG. 11C, the control board 70 is not illustrated. In addition, in FIG. 9A to FIG. 11C, only the cover 30 of the fixed portion 20a is displayed.

Descriptions in FIG. 9A to FIG. 11C are based on the directions relative to the respective project plan views. Specifically, the −Z direction is the rearward, the +X direction is the leftward, the +Y direction is the upward, and the −Y direction is the downward.

First, the first image capturing FPC 61 will be described using FIG. 9A and FIG. 9B.

The first image capturing FPC 61 is constituted by a first wiring portion 61a, a first connecting portion 61b, and a second connecting portion 61c, and a power supply wiring is formed that is electrically connected from the first connecting portion 61b to the second connecting portion 61c via the first wiring portion 61a. The first connecting portion 61b of the first image capturing FPC 61 is connected to the image sensor 11 and the second connecting portion 61c is connected to the control board 70. The first image capturing FPC 61 includes a ground wiring and wirings necessary for the image sensor 11 in addition to the power supply wiring.

The first wiring portion 61a extends downward from the first connecting portion 61b, then curves rearward, passes through a first opening 30a of the cover 30, and extends upward. Thereafter, the first wiring portion 61a is fixed to the cover 30 with a double-sided tape at a first attachment portion 65 that is a leftward curved end. The first wiring portion 61a curves (bends) in a way from the first attachment portion 65 and extends upward. Thereafter, the first wiring portion 61a curves rearward and connected to the second connecting portion 61c. Here, the first wiring portion 61a includes a first linear portion 61d from the first connecting portion 61b to a portion that is curved first, a first curved portion 61e that is curved first, and a second linear portion 61f continued from the first curved portion 61e. As shown in FIG. 9B, the second linear portion 61f is a straight line when viewed from the X direction, but has two curved portions in the XY plane, a portion parallel to the first linear portion 61d, and a portion orthogonal to the first linear portion 61d. Although the second linear portion 61f has two curved portions in the XY plane in the present embodiment, it may have three or more curved portions.

The first image capturing FPC 61 is attached to the cover 30, which is a component of the fixed portion 20a, at the first attachment portion 65. Therefore, the first image capturing FPC 61 becomes a fixed part in a range from the second connecting portion 61c to the first attachment portion 65, whereas it deforms in a range from the first connecting portion 61b to the first attachment portion 65 in accordance with the movement of the movable portion 20b. Therefore, a slit 61s is provided in the first image capturing FPC 61 in order to reduce the driving load of the FPC during the movement of the movable portion 20b in the X direction. A width of the first wiring portion 61a including the slit 61s is referred to as a first width W1 (FIG. 11C).

The second image capturing FPC 62 will be described using FIG. 10A and FIG. 10B. The second image capturing FPC 62 is constituted by a second wiring portion 62a, a third connecting portion 62b, and a fourth connecting portion 62c, and a power supply wiring is formed that is electrically connected from the third connecting portion 62b to the fourth connecting portion 62c via the second wiring portion 62a. The third connecting portion 62b of the second image capturing FPC 62 is connected to the image sensor 11 and the fourth connecting portion 62c is connected to the control board 70. The second image capturing FPC 62 includes a ground wiring and wirings necessary for the image sensor 11 in addition to the power supply wiring.

The second wiring portion 62a extends downward from the third connecting portion 62b, then curves rearward, passes through the first opening 30a of the cover 30, and extends upward. The second wiring portion 62a overlaps the first wiring portion 61a from the middle, and is fixed to the first wiring portion 61a and the cover 30 with a double-sided tape at a second attachment portion 66. The second wiring portion 62a then curves rearward and joins to the fourth connecting portion 62c. Here, the second wiring portion 62a includes a third linear portion 62d from the third connecting portion 62b to a portion that is curved first, a second curved portion 62e that is curved first, and a fourth linear portion 62f continued from the second curved portion 62e.

The second image capturing FPC 62 is attached to the cover 30, which is a component of the fixed portion 20a, and the fixed part of the first image capturing FPC 61 (the range from the second connecting portion 61c to the first attachment portion 65) at the second attachment portion 66 in the middle. Therefore, the second image capturing FPC 62 deforms in the range from the third connecting portion 62b to the second attachment portion 66 in accordance with the movement of the movable portion 20b. Therefore, a slit 62s is provided in the second image capturing FPC 62 in order to reduce the driving load of the FPC during the movement of the movable portion 20b in the X direction. A width of the second wiring portion 62a including the slit 62s is referred to as a second width W2 (FIG. 11C).

Next, the third image capturing FPC 63 will be described using FIG. 11A to FIG. 11C.

The third image capturing FPC 63 includes a third wiring portion 63a, a fifth connecting portion 63b, and a sixth connecting portion 63c, and a high-speed transmission wiring electrically connected from the fifth connecting portion 63b to the sixth connecting portion 63c via the third wiring portion 63a is formed. As the high-speed transmission wiring, for example, a differential transmission wiring is employed. The image capturing apparatus 10 transmits the image capturing signal between the image sensor 11 and the control board 70 using the high-speed transmission wiring, and supports high-speed transmission of the image capturing signal. The fifth connecting portion 63b of the third image capturing FPC 63 is connected to the image sensor 11 and the sixth connecting portion 63c is connected to the control board 70. The third image capturing FPC 63 includes a ground wiring and wirings necessary for the image sensor 11 in addition to the high-speed transmission wiring.

The third wiring portion 63a extends upward from the fifth connecting portion 63b, then curves rearward, passes through a second opening 30b of the cover 30, and extends downward. The third image capturing FPC 63 is fixed to the cover 30 at a third attachment portion 67 with a double-sided tape. The third wiring portion 63a then curves rearward and joins to the sixth connecting portion 63c. Here, the third wiring portion 63a includes a fifth linear portion 63d from the fifth connecting portion 63b to a portion that is curved first, a third curved portion 63e that is curved first, and a sixth linear portion 63f continued from the third curved portion 63e.

Since the third image capturing FPC 63 is attached to the cover 30, which is the component of the fixed portion 20a, at the third attachment portion 67 in the middle, the third image capturing FPC 63 deforms in the range from the fifth connecting portion 63b to the third attachment portion 67 in accordance with the movement of the movable portion 20b. Therefore, a slit 63s is provided in the third image capturing FPC 63 in a part of the deformable portion that deforms in accordance with the movement of the movable portion 20b in order to reduce the driving load of the FPC during the movement of the movable portion 20b in the X direction. A width of the third wiring portion 63a including the slit 63s is referred to as a third width W3 (FIG. 11C).

Next, a relationship between the third image capturing FPC 63 and the first image capturing FPC 61 will be described.

As shown in FIG. 11A, the third image capturing FPC 63 (a second wiring member) and the first image capturing FPC 61 (a first wiring member) are arranged to overlap when viewed from the rear side. As shown in FIG. 11C, an overlapped amount between the third image capturing FPC 63 and the first image capturing FPC 61 in the X direction is represented as W4 (a predetermined amount).

A Total Width WF1 of the Image Capturing FPC Group 60 is Represented by the Following Equation.

$$WF 1 = W 1 + W 2 + W 3$$

On the other hand, a total width W6 of the image capturing FPC group 60 when viewed from the rear side is represented by the following equation.

$$W 6 = W 1 + W 2 + W 3 - W 4$$

As described above, since the third image capturing FPC 63 and the first image capturing FPC 61 are partially overlapped, the total width W6 of the image capturing FPC group 60 when viewed from the rear side can be smaller than the total width WF1 of the image capturing FPC group 60 by W4.

On the other hand, as shown in FIG. 11B, the first image capturing FPC 61 (the first wiring member) and the third image capturing FPC 63 (the second wiring member) are separated by Z1 in the optical axis direction (Z direction). In this way, since the first image capturing FPC 61 and the third image capturing FPC 63 are separated in the optical axis direction while overlapping by W4 when viewed from the rear side (in the optical axis direction), the first image capturing FPC 61 and the third image capturing FPC 63 are prevented from interfering when the movable portion 20b is driven. In the third image capturing FPC 63, the ground wiring is wired in a portion overlapping by the predetermined amount, and the differential-transmission wiring is wired in a portion excluding the overlapping portion.

Although the first image capturing FPC 61 and the third image capturing FPC 63 extend in different directions (+Y direction and −Y direction) in the portion overlapping by W4 in the present embodiment, this configuration is not limited. For example, in a second embodiment described later, a first image capturing FPC 161 and a third image capturing FPC 163 are separated in the optical axis direction and extend in substantially the same direction (+Y direction) in a portion overlapping by W14 (a predetermined amount) when viewed from the rear side.

Although the first image capturing FPC 61 and the third image capturing FPC 63 overlap each other by W4 when viewed from the rear side, this configuration is not limited. For example, as in the second embodiment described later, the first image capturing FPC 161 and the third image capturing FPC 163 may be overlapped by W14, and a second image capturing FPC 162 and the third image capturing FPC 163 may be overlapped by W15 when viewed from the rear side.

The configuration described above enables the image capturing FPC group 60 to be routed in a limited space inside the image capturing apparatus 10 even when the total width WF1 of the wiring portions of the image capturing FPC group 60 is large. This can suppress an increase in the size of the image stabilization unit 20 and an increase in the size of the image capturing apparatus 10.

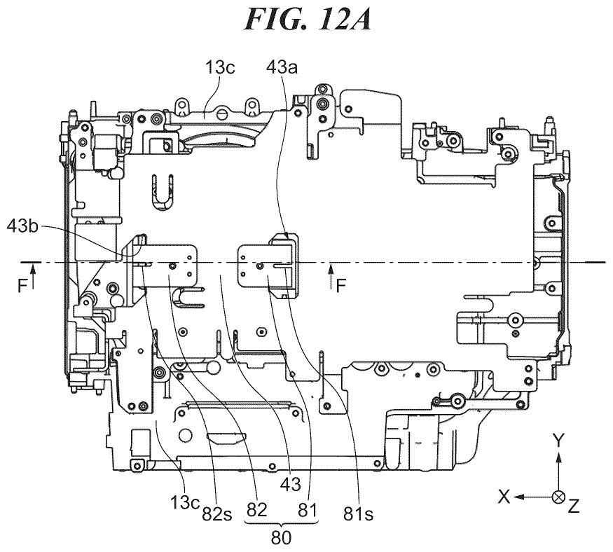

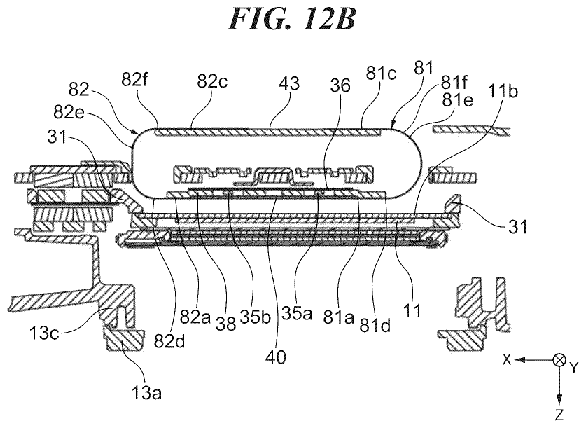

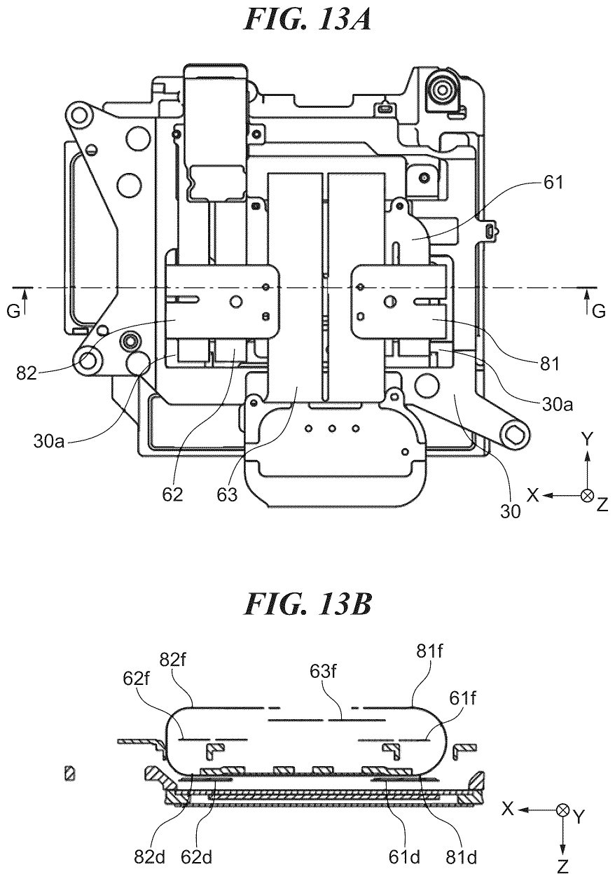

Next, a heat dissipation path of the image sensor 11 will be described using FIG. 8, FIG. 12A, FIG. 12B, FIGS. 13A, and 13B. FIG. 12A is a projected plan view in the optical axis direction illustrating constituent parts of the heat dissipation path of the image sensor 11. The FIG. 12B is a sectional view along a line F-F shown in FIG. 12A. FIG. 13A is a projected plan view in the optical axis direction illustrating the image stabilization unit 20. FIG. 13B is a sectional view along a line G-G shown in FIG. 13A.

Heat generated by the image sensor 11 is transferred to the generally rectangular shaped image sensor board 11b to which the image sensor 11 is fixed through a die-bonding process. The image sensor board 11b is a rigid board and has a region partially overlapping the image sensor holder 31, and is in surface contact with the image sensor holder 31 in the region to transfer heat.

The image sensor holder 31 is formed by magnesium die casting or aluminum die casting. The image sensor holder 31 transfers heat that has been transferred from the image sensor board 11b to the coupling member 38 at three fixing positions with the screws 45 (FIG. 5).

The coupling member 38 is made from aluminum alloy. The heat transfer member group 80 is connected to the coupling member 38, and the support member 43 is connected to the heat transfer member group 80.

As shown in FIG. 12A, the support member 43 is connected to the base member 13c. As shown in FIG. 12B, one end of heat transfer member group 80 is connected to the coupling member 38 of the movable portion 20b and the other end is connected to the support member 43 of the fixed portion 20a. That is, the coupling member 38 is movable with respect to the support member 43. Details of the heat transfer member group 80 will be described later.

Accordingly, the heat generated by the image sensor 11 and transferred from the image sensor holder 31 to the coupling member 38 is transferred to the support member 43 via the heat transfer member group 80. The heat transferred to the support member 43 is transferred to the base member 13c, and is finally radiated from the base member 13c to the outside air. The support member 43 is made from aluminum alloy, and the base member 13c is made by magnesium die casting or aluminum die casting.

Next, the routing of the heat transfer member group 80 will be described.

As shown in the FIG. 12A, the heat transfer member group 80 is constituted by a first heat transfer member 81 and a second heat transfer member 82 that are provided at opposite positions when viewed from the Z direction. The descriptions in FIG. 12A, FIG. 12B, FIG. 13A, and FIG. 13B will be made with reference to the directions with respect to the projected plan view. For example, the −Z direction is the rearward direction, the +X direction is the leftward direction, and the −X direction is the rightward direction.

The first heat transfer member 81 is constituted by a first attachment portion 81a fixed to the coupling member 38 with a double-sided tape, a second attachment portion 81c fixed to the support member 43 with a double-sided tape, and a first heat transfer portion coupling therebetween. The first heat transfer member 81 extends rightward from the first attachment portion 81a, then curves rearward, passes through the first opening 30a of the cover 30 as illustrated in FIG. 13A, further passes through an opening 43a of the support member 43 as indicated in FIG. 12A, then extends leftward, and is connected to the second attachment portion 81c. Here, the first heat transfer portion includes a first linear portion 81d from the first attachment portion 81a to a portion that is curved first, a first curved portion 81e that is curved first, and a second linear portion 81f continued from the first curved portion 81e.

The second heat transfer member 82 is constituted by a third attachment portion 82a fixed to the coupling member 38 with a double-sided tape, a fourth attachment portion 82c fixed to the support member 43 with a double-sided tape, and a second heat transfer portion coupling therebetween. The second heat transfer member 82 extends leftward from the third attachment portion 82a, then curves rearward, passes through the first opening 30a of the cover 30 as illustrated in FIG. 13A, further passes through a cutout 43b of the support member 43 as illustrated in FIG. 13B, then extends rightward, and is connected to the fourth attachment portion 82c. Here, the second heat transfer portion includes a third linear portion 82d from the third attachment portion 82a to a portion that is curved first, a second curved portion 82e that is curved first, and a fourth linear portion 82f continued from the second curved portion 82e.

Since one end of the heat transfer member group 80 is connected to the coupling member 38 of the movable portion 20b and the other end is connected to the support member 43 of the fixed portion 20a, the heat transfer member group 80 deforms in accordance with the movement of the movable portion 20b. Therefore, the heat transfer member group 80 is made of a flexible sheet member, such as a graphite sheet of which thickness is 0.1 mm, so as not to inhibit the movement of the movable portion 20b. The graphite sheet has a higher thermal conductivity than the coupling member 38, and thus the heat transfer member group 80 can efficiently transfer the heat from the coupling member 38 to the support member 43. Further, the first heat transfer member 81 is provided with a slit 81s and the second heat transfer member 82 is provided with a slit 82s in order to reduce the driving load of the heat transfer member group 80 during the movement of the movable portion 20b in the Y direction.

Next, the routings of the image capturing FPC group 60 (the first image capturing FPC 61, second image capturing FPC 62, and third image capturing FPC 63) and the heat transfer member group 80 (the first heat transfer member 81 and the second heat transfer member 82) will be described using FIG. 13A and FIG. 13B.

As described above, the first image capturing FPC 61 and the second image capturing FPC 62 extend downward from the image sensor 11 so as to be away from the optical axis 12a, then curve rearward and extend upward. The third image capturing FPC 63 extends upward from the image sensor 11 so as to be away from the optical axis 12a, then curves rearward, and extends downward. The first heat transfer member 81 extends rightward from the coupling member 38 so as to be away from the optical axis 12a, then curves rearward, and extends leftward. The second heat transfer member 82 extends leftward from the coupling member 38 so as to be away from the optical axis 12a, then curves rearward, and extends rightward.

As described above, the FPCs of the image capturing FPC group 60 are arranged such that the width direction of the wiring portions is along a long-side direction (X direction) of the image sensor 11 and are routed in a short-side direction (Y direction) of the image sensor 11 as illustrated in FIG. 11A. On the other hand, the members of the heat transfer member group 80 are routed in the long-side direction (X direction) of the image sensor 11. In this way, since the FPCs of the image capturing FPC group 60 are arranged such that the width direction of the wiring portions is the long-side direction of the image sensor 11, the image capturing FPC group 60 of which the total width of the wiring portions is large can be arranged as compared with a case where the width direction of wiring portions is the short-side direction of the image sensor 11.

In addition, when the attachment portion of the movable portion 12a is set as a starting point, the image capturing FPC group 60 and the heat transfer member group 80 extend outward (in directions away from the optical axis 20b) in four different extending directions of upward, downward, leftward, and rightward directions, respectively, then curve rearward, and extend inward. Here, the first image capturing FPC 61 and the first heat transfer member 81 are focused using FIG. 13B. When viewed in the optical axis direction (Z direction), the first linear portion 61d of the first image capturing FPC 61, the first linear portion 81d of the first heat transfer member 81, the second linear portion 61f of the first image capturing FPC 61, and the second linear portion 81f of the first heat transfer member 81 are arranged in this order. The sixth linear portion 63f of the third image capturing FPC 63 is disposed between the second linear portion 61f of the first image capturing FPC 61 and the second linear portion 81f of the first heat transfer member 81 so as to partially overlap with each other. On the other hand, when viewed from the rear side, the first linear portion 61d of the first image capturing FPC 61, the first linear portion 81d of the first heat transfer member 81, the second linear portion 61f of the first image capturing FPC 61, and the second linear portion 81f of the first heat transfer member 81 are partially overlapped at least.

Next, the second image capturing FPC 62 and the second heat transfer member 82 are focused. When viewed in the optical axis direction, the third linear portion 62d of the second image capturing FPC 62, the third linear portion 82d of the second heat transfer member 82, the fourth linear portion 62f of the second image capturing FPC 62, and the fourth linear portion 82f of the second heat transfer member 82 are arranged in this order. On the other hand, when viewed from the rear side, the third linear portion 62d of the second image capturing FPC 62, the third linear portion 82d of the second heat transfer member 82, the fourth linear portion 62f of the second image capturing FPC 62, and the fourth linear portion 82f of the second heat transfer member 82 are partially overlapped at least.

Since the image capturing FPC group 60 and the heat transfer member group 80 arranged in the limited space while keeping large radii of curvatures of the curved portions as described above, the image capturing FPC group 60 and the heat transfer member group 80 can be compactly routed while reducing the load during the movement of the movable portion 20b. This enables to suppress an increase in the size of the image stabilization unit 20 and an increase in the size of the image capturing apparatus 10 while achieving both an increase in the number of signals and an improvement in heat dissipation performance in association with high functionality of the image sensor 11. Further, since the image capturing FPC group 60 and the heat transfer member group 80 are routed in the different directions, it is possible to disperse the driving load of the image capturing FPC group 60 and the heat transfer member group 80 during the movement of the movable portion 20b.

Although the configuration in which the components of the image capturing FPC group 60 and the components of the heat transfer member group 80 are alternately arranged when viewed in the optical axis direction has been described in the present embodiment, this is not limited. For example, the first linear portion 61d of the first image capturing FPC 61, the first linear portion 81d of the first heat transfer member 81, the second linear portion 81f of the first heat transfer member 81, and the second linear portion 61f of the first image capturing FPC 61 may be arranged in this order.

In the present embodiment, the first heat transfer member 81 and the second heat transfer member 82 are described as separate components. However, an integral component may extend from the coupling member to the left and right.

Further, the image capturing FPC group 60 (the first image capturing FPC 61, the second image capturing FPC 62, and the third image capturing FPC 63) is routed in the vertical direction, and the heat transfer member group 80 (the first heat transfer member 81 and the second heat transfer member 82) is routed in the horizontal direction in the present embodiment. However, this is not necessarily limited. The image capturing FPC group 60 and the heat transfer member group 80 may be routed in any combination of directions. For example, the image capturing FPC group 60 may be routed in the horizontal direction and the heat transfer member group 80 may be routed in the vertical direction, or the image capturing FPC group 60 may be routed in the leftward direction and the upward direction and the heat transfer member group 80 may be routed in the rightward direction and the downward direction.

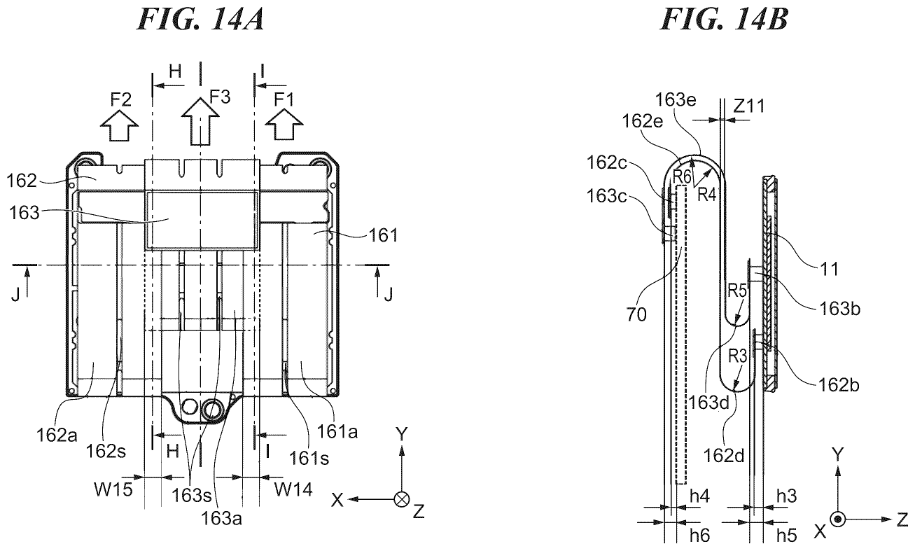

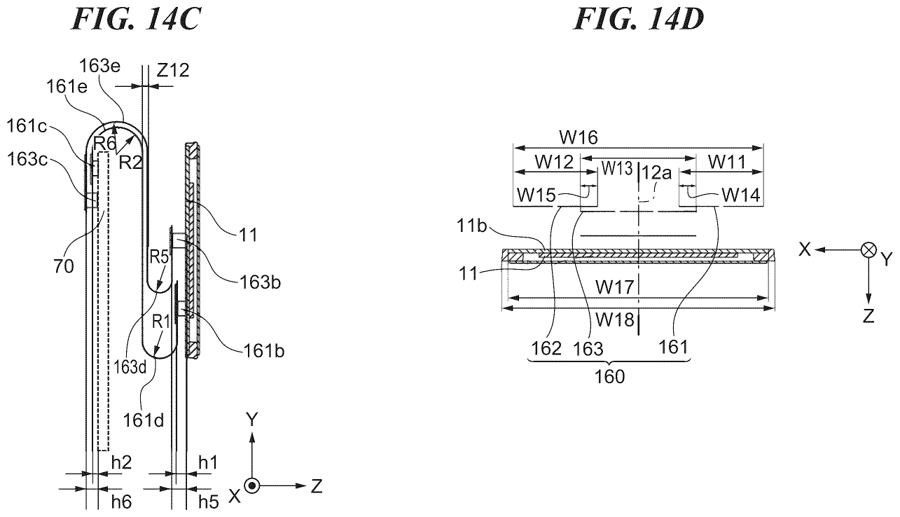

Next, a second embodiment of the present invention will be described. The second embodiment of the present invention is different mainly in that first, second, and third image capturing FPCs 161, 162, and 163 having different configurations are provided instead of the first, second, and third image capturing FPCs 61, 62, and 63 in the first embodiment. Hereinafter, the present embodiment will be described using FIG. 14A to FIG. 14D. In the present embodiment, the same components as those of the image capturing apparatus 10 in the first embodiment are denoted by the same reference numerals, and the duplicated descriptions will be omitted.

FIG. 14A to FIG. 14D are a projected plan view in the optical axis direction of and sectional views illustrating an image capturing FPC group 160 of the second embodiment. FIG. 14A is the projected plane view, FIG. 14B is the sectional view along a line H-H shown in FIG. 14A, FIG. 14C is the sectional view along a line I-I shown in FIG. 14A, and FIG. 14D is the sectional view along a line J-J shown in FIG. 14A. Descriptions in FIG. 14A to FIG. 14D are based on the directions relative to the projected plan view. Specifically, the −Z direction is the rearward, the +X direction is the leftward, the +Y direction is the upward, and the −Y direction is the downward.

As shown in FIG. 14A and FIG. 14D, the image capturing FPC group 160 includes the first image capturing FPC 161, the second image capturing FPC 162, and the third image capturing FPC 163.

First, the first image capturing FPC 161 will be described using FIG. 14A to FIG. 14D.

The first image capturing FPC 161 is constituted by a first wiring portion 161a, a first connecting portion 161b, and a second connecting portion 161c, and a power supply wiring is formed that is electrically connected from the first connecting portion 161b to the second connecting portion 161c via the first wiring portion 161a. The first connecting portion 161b of the first image capturing FPC 161 is connected to the image sensor 11 and the second connecting portion 161c is connected to the control board 70. The first image capturing FPC 161 includes a ground wiring and wirings necessary for the image sensor 11 in addition to the power supply wiring.

As shown in FIG. 14C, the first wiring portion 161a extends downward from the first connecting portion 161b, then curves rearward at a first curved portion 161d and extends upward. Thereafter, the first wiring portion 161a curves rearward at a second curved portion 161e and connects to the second connecting portion 161c.

The first image capturing FPC 161 deforms in a range from the first connecting portion 161b to the second connecting portion 161c in accordance with the movement of the movable portion 20b. Therefore, a slit 161s is provided in the first image capturing FPC 161 in order to reduce the driving load of the first image capturing FPC 161 during the movement of the movable portion 20b in the X direction. A width of the first wiring portion 161a including the slit 161s is W11 (FIG. 14D). As shown in FIG. 14C, a height of the first connecting portion 161b from the image sensor 11 is h1, a height of the second connecting portion 161c from the control board 70 is h2, an inside diameter of the first curved portion 161d is R1, and an inside diameter of the second curved portion 161e is R2.

The second image capturing FPC 162 will now be described using FIG. 14A and FIG. 14B.

The second image capturing FPC 162 is constituted by a second wiring portion 162a, a third connecting portion 162b, and a fourth connecting portion 162c, and a power supply wiring is formed that is electrically connected from the third connecting portion 162b to the fourth connecting portion 162c via the second wiring portion 162a. The third connecting portion 162b of the second image capturing FPC 162 is connected to the image sensor 11 and the fourth connecting portion 162c is connected to the control board 70. The second image capturing FPC 162 includes a ground wiring and wirings necessary for the image sensor 11 in addition to the power supply wiring.

As shown in FIG. 14B, the second wiring portion 162a extends downward from the third connecting portion 162b, then curves rearward at a first curved portion 162d and extends upward. Thereafter, the second wiring portion 162a curves rearward at a fourth curved portion 162e and connects to the fourth connecting portion 162c.

The second image capturing FPC 162 deforms in a range from the third connecting portion 162b to the fourth connecting portion 162c in accordance with the movement of the movable portion 20b. Therefore, a slit 162s is provided in the second image capturing FPC 162 in order to reduce the driving load of the second image capturing FPC 162 during the movement of the movable portion 20b in the X direction. A width of the second wiring portion 162a including the slit 162s is W2 (FIG. 14D). As shown in FIG. 14B, a height of the third connecting portion 162b from the image sensor 11 is h3, a height of the fourth connecting portion 162c from the control board 70 is h4, an inside diameter of the third curved portion 162d is R3, and an inside diameter of the fourth curved portion 162e is R4.

Next, the third image capturing FPC 163 will be described using FIG. 14A to FIG. 14D.

The third image capturing FPC 163 includes a third wiring portion 163a, a fifth connecting portion 163b, and a sixth connecting portion 163c, and a high-speed transmission wiring electrically connected from the fifth connecting portion 163b to the sixth connecting portion 163c via the third wiring portion 163a is formed. As the high-speed transmission wiring, for example, a differential transmission wiring is employed. The image capturing apparatus 10 transmits the image capturing signal between the image sensor 11 and the control board 70 using the high-speed transmission wiring, and supports high-speed transmission of the image capturing signal. The third image capturing FPC 163 includes a ground wiring and wirings necessary for the image sensor 11 in addition to the high-speed transmission wiring.

As shown in FIG. 14B and FIG. 14C, the third wiring portion 163a extends downward from the fifth connecting portion 163b, then curves rearward at a fifth curved portion 163d, and extends upward. Thereafter, the third wiring portion 163a curves rearward at a sixth curved portion 163e and connects to the sixth connecting portion 163c.

The third image capturing FPC 163 deforms in a range from the fifth connecting portion 163b to the sixth connecting portion 163c in accordance with the movement of the movable portion 20b. Therefore, a slit 163s is provided in the third image capturing FPC 163 in order to reduce the driving load of the third image capturing FPC 163 during the movement of the movable portion 20b in the X direction. A width of the third wiring portion 163a including the slit 163s is W13 (FIG. 14D). As shown in FIG. 14B and FIG. 14C, a height of the fifth connecting portion 163b from the image sensor 11 is h5, a height of the sixth connecting portion 163c from the control board 70 is h6, an inside diameter of the fifth curved portion 163d is R5, and an inside diameter of the sixth curved portion 163e is R6.

As shown in FIG. 14D, the third image capturing FPC 163 and the first image capturing FPC 161 are routed substantially parallel to the short-side direction of the image sensor 11 when viewed from the rear side and overlap by a width W14. The third image capturing FPC 163 and the second image capturing FPC 162 are also routed substantially parallel to the short-side direction of the image sensor 11 when viewed from the rear side and overlap by a width W15.

A total width WF11 of the image capturing FPC group 160 is represented by the following equation.

$$WF 11 = W 11 + W 12 + W 13$$

On the other hand, a total width W16 of the image capturing FPC group 160 when viewed from the rear side is represented by the following equation.

$$W 16 = W 11 + W 12 + W 13 - ( W 14 + W 15 )$$

Further, a width W17 of the image sensor 11 fixed to the image sensor board 11b (a length in the X direction (long-side direction)) and a width W18 (a length in the X direction) of the image sensor board 11b satisfy the following relationship in the present embodiment.

$$W 16 < W 17 < W 18 < W F 11$$

As described above, the third image capturing FPC 163 overlaps with the first image capturing FPC 161, and the third image capturing FPC 163 overlaps with the second image capturing FPC 162. Thus, the image capturing FPC group 160 having the width wider than the width of the image sensor 11 falls within a range overlapping the image sensor 11 in the width direction of the image sensor 11 when viewed from the optical axis direction.

Next, the relationship between the FPCs of the image capturing FPC group 160 in the optical axis direction will be described using FIG. 14B and FIG. 14C. FIG. 14B is the sectional view illustrating the overlapping portion between the third image capturing FPC 163 and the second image capturing FPC 162. FIG. 14C is the sectional view illustrating the overlapping portion between the third image capturing FPC 163 and the first image capturing FPC 161.

As shown in FIG. 14B, a height h5 of the fifth connecting portion 163b of the third image capturing FPC 163 is higher than a height h3 of the third connecting portion 162b of the second image capturing FPC 162, so that the heights h3 and h5 are different from each other. An inside diameter R5 (a second inside diameter) of the fifth curved portion 163d of the third image capturing FPC 163 is smaller than an inside diameter R3 (a first inside diameter) of the third curved portion 162d of the second image capturing FPC 162, so that the inside diameters R3 and R5 are different from each other. Further, a height h6 of the sixth connecting portion 163c of the third image capturing FPC 163 is higher than a height h4 of the fourth connecting portion 162c of the second image capturing FPC 162. An inside diameter R6 of the sixth curved portion 163e of the third image capturing FPC 163 is larger than an inside diameter R4 of the fourth curved portion 162e of the second image capturing FPC 162. With the above configuration, the third image capturing FPC 163 is separated from the second image capturing FPC 162 by Z11 in the optical axis direction.

Similarly, as shown in FIG. 14C, the height h5 of the fifth connecting portion 163b of the third image capturing FPC 163 is higher than a height h1 of the first connecting portion 161b of the first image capturing FPC 161. The inside diameter R5 of the fifth curved portion 163d of the third image capturing FPC 163 is smaller than an inside diameter R1 of the first curved portion 161d of the first image capturing FPC 161. Further, the height h6 of the sixth connecting portion 163c of the third image capturing FPC 163 is higher than a height h2 of the second connecting portion 161c of the first image capturing FPC 161. The inside diameter R6 of the sixth curved portion 163e of the third image capturing FPC 163 is larger than an inside diameter R2 of the second curved portion 161e of the first image capturing FPC 161. With the above configuration, the third image capturing FPC 163 is separated from the first image capturing FPC 161 by Z12 in the optical axis direction.

With the above configuration, even when the third image capturing FPC 163 overlaps with the second image capturing FPC 162 when viewed from the rear side, the third image capturing FPC 163 is separated from the second image capturing FPC 162 in the optical axis direction, which prevents interference between the third image capturing FPC 163 and the second image capturing FPC 162 during driving of the movable portion 20b. Further, even when the third image capturing FPC 163 overlaps with the first image capturing FPC 161 when viewed from the rear side, the third image capturing FPC 163 is separated from the first image capturing FPC 161 in the optical axis direction, which prevents interference between the third image capturing FPC 163 and the first image capturing FPC 161 during driving of the movable portion 20b.

The configuration described above enables the image capturing FPC group 160 to be routed in a limited space inside the image capturing apparatus 10 even when the total width (WF11) of the wiring portions of the image capturing FPC group 160 is large. This can suppress an increase in the size of the image stabilization unit 20 and an increase in the size of the image capturing apparatus 10.

As shown in FIG. 14D, the image capturing FPC group 160 is disposed so as to extend substantially symmetrically in the horizontal direction with respect to the optical axis 12a in the present embodiment. Specifically, the third image capturing FPC 163 is arranged so as to extend substantially symmetrically about the optical axis. In addition, the first image capturing FPC 161 and the second image capturing FPC 162 are arranged so as to extend substantially symmetrically in the horizontal direction with respect to the optical axis 12a. Further, the first image capturing FPC 161 and the second image capturing FPC 162 are substantially identical in the width, thickness, and length.

For example, when the movable portion 20b is moved downward, an upward restoring force F1 is applied to the first image capturing FPC 161, an upward restoring force F2 is applied to the second image capturing FPC 162, and an upward restoring force F3 is applied to the third image capturing FPC 163 as shown in the FIG. 14A. Since the restoring forces F1 and F2 are substantially equal to each other and the restoring forces are applied substantially symmetrically with respect to the center of the optical axis in the above configuration, it is possible to suppress generation of an unnecessary rotational force due to the restoring forces.

Although the image capturing FPC group 160 is arranged so as to extend substantially symmetrically in the horizontal direction in the present embodiment, the image capturing FPC group 160 may be arranged so as to extend substantially symmetrically in the vertical direction.

In general, electromagnetic field noise may be generated from a high-speed transmission wiring. When the electromagnetic field noise enters another FPC, there is a possibility that the camera function is adversely affected. In the present embodiment, although the third image capturing FPC 163 includes the high-speed transmission wiring, the high-speed transmission wiring is provided in a portion excluding the overlapping portion (W14) with the first image capturing FPC 161 and the overlapping portion (W15) with the second image capturing FPC 162. On the other hand, the ground wiring is provided in the overlapping portion (W14) with the first image capturing FPC 161 and the overlapping portion (W15) with the second image capturing FPC 162. This prevents the electromagnetic field noise generated in the third image capturing FPC 163 from entering the first image capturing FPC 161 and the second image capturing FPC 162.

### OTHER EMBODIMENTS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-063885, filed Apr. 11, 2024, which is hereby incorporated by reference herein in its entirety.

What is claimed is:

1. An image capturing apparatus comprising:
an image sensor;
a first unit;
a second unit on which the image sensor is arranged so as to move that the image sensor relative to the first unit in a plane orthogonal to an optical axis of an image capturing optical system; and
a first wiring member and a second wiring member that electrically connect the first unit and the second unit,
wherein the first wiring member and the second wiring member overlap by a predetermined amount when viewed from an optical axis direction of the image capturing optical system and are separated in the optical axis direction in a portion overlapping by the predetermined amount.

2. The image capturing apparatus according to claim 1, wherein the first wiring member and the second wiring member extend in substantially the same direction in the portion overlapping by the predetermined amount.

3. The image capturing apparatus according to claim 1, wherein the first wiring member and the second wiring member extend in different directions in the portion overlapping by the predetermined amount.

4. The image capturing apparatus according to claim 1, wherein the first wiring member and the second wiring member respectively include curved portions, and
a first inner diameter of the curved portion of the first wiring member is different from a second inner diameter of the curved portion of the second wiring member.

5. The image capturing apparatus according to claim 1, wherein the first unit includes a control board,
the first wiring member and the second wiring member electrically connect the image sensor and the control board, and
a height of a connecting portion of the first wiring member to the image sensor is different from a height of a connecting portion of the second wiring member to the image sensor.

6. The image capturing apparatus according to claim 1, wherein image sensor is substantially rectangular when viewed from the optical axis direction,
the first wiring member and the second wiring member extend substantially in parallel to a short-side direction of the image sensor in the portion overlapping by the predetermined amount, and fall within a range overlapping the image sensor in a long-side direction of the image sensor when viewed from the optical axis direction.

7. The image capturing apparatus according to claim 1, wherein an image sensor board for fixing the image sensor has a substantially rectangular shape when viewed from the optical axis direction, and
the first wiring member and the second wiring member extend substantially in parallel to a short-side direction of the image sensor board in the portion overlapping by the predetermined amount, and fall within a range overlapping the image sensor board in a long-side direction of the image sensor board when viewing in the optical axis direction.

8. The image capturing apparatus according to claim 1, wherein the first wiring member and the second wiring member extend substantially symmetrically with respect to the optical axis.

9. The image capturing apparatus of claim 1, wherein at least one of the first wiring member and the second wiring member includes a high-speed transmission wiring and a ground wiring, and the ground wiring is provided in the portion overlapping by the predetermined amount, and the high-speed transmission wiring is provided in a portion excluding the portion overlapping by the predetermined amount.
